(19) United States
(12) Patent Application Publication
(10) Pub. No.: US 2020/0302772 A1
(43) Pub. Date: Sep. 24, 2020

(54) ELECTRONIC DEVICE AND METHOD FOR MANAGING ARTICLES THEREBY

(71) Applicant: Samsung Electronics Co., Ltd., Suwon-si, Gyeonggi-do (KR)

(72) Inventor: Insung CHO, Seoul (KR)

(21) Appl. No.: 16/339,262

(22) PCT Filed: Sep. 29, 2017
(86) PCT No.: PCT/KR2017/011086

§ 371 Date: Apr. 3, 2019

(30) Foreign Application Priority Data
Oct. 14, 2016 (KR) 10-2016-0133612

(51) Int. Cl. G08B 21/24; G06F 16/245; G06F 16/23; H04W 4/80; H04W 4/029

(52) U.S. Cl. CPC G08B 21/24; G06F 16/245; H04W 4/029; H04W 4/80; G06F 16/2379

(57) ABSTRACT

An electronic device according to various embodiments of the present invention comprises: a display; a communication module supporting short-range communication; a processor electrically connected to the display and the communication module; and a memory electrically connected to the processor, wherein the memory may store instructions that, when executed, cause the processor to: determine whether at least one predetermined article management condition has occurred; when it is determined that the article management condition has occurred, search for a signal, transmitted by at least one signal transmission apparatus, by controlling the communication module; receive the searched signal from the at least one signal transmission apparatus which transmits the signal; configure a list of articles corresponding to the article management condition on the basis of a database which includes data on articles and is stored in at least one of the memory and at least one external electronic device; and store, in the memory and the at least one external electronic device, the configured list of the articles corresponding to the article management condition. In addition, various embodiments are possible.

### CROSS-REFERENCE TO RELATED APPLICATIONS

This application is a 371 National Stage of International Application No. PCT/KR2017/011086, filed Sep. 29, 2017, which claims priority to Korean Patent Application No. No. 10-2016-0133612, filed Oct. 14, 2016, the disclosures of which are herein incorporated by reference in their entirety.

### BACKGROUND

### 1. Field

Various embodiments of the present invention relate to an electronic device and method for managing articles, and more particularly, to an electronic device and method for managing personal belongings and preventing loss of such belongings through wireless communication technology.

### 2. Description of Related Art

Generally, an electronic device such as a smart phone or a tablet PC can communicate with external devices by using a wireless communication function. In recent years, a beacon technique for periodically transmitting a signal including low-capacity data has been widely used in marketing related to electronic devices, home automation, location identification services, and the like. Typically, a beacon technique based on Bluetooth low energy (BLE) is used for low power communication. For example, when a beacon is attached to each of user's belongings, each beacon may send a beacon signal containing its own identification (ID) data to an electronic device, and the electronic device may provide various contents to the user by using the received beacon signal.

### SUMMARY

When the beacon technique is used for managing such belongings, the electronic device may search for beacon signals transmitted from the respective beacons attached to the belongings in response to a user's manipulation or periodically, thereby checking a current state of each belonging or whether each belonging is lost. However, in case of searching for beacon signals in response to a user's manipulation, this search is performed only when there is a user's search request, and it is therefore difficult to prevent the loss of belongings. On the other hand, in case of searching for beacon signals periodically regardless of a user's search request, this search is performed periodically even in a situation where the user is staying in a certain place or where there is no need to check the current state or loss of each belonging. This may cause unnecessary power consumption.

According to various embodiments of the present invention, an electronic device comprises a display; a communication module supporting short-range communication; a processor electrically connected to the display and the communication module; and a memory electrically connected to the processor, wherein the memory may store instructions that cause, when executed, the processor to determine whether at least one predetermined article management condition occurs, to, when the article management condition occurs, control the communication module to search for a signal transmitted by at least one signal transmission device and to receive the signal from the at least one signal transmission device which transmits the signal, to construct a list of articles corresponding to the article management condition, based on a database which contains data on articles and is stored in at least one of the memory and at least one external electronic device, and to store the constructed list of articles corresponding to the article management condition in the memory and the at least one external electronic device.

According to various embodiments of the present invention, a server may comprise a communication module; a processor electrically connected to the communication module; and a memory electrically connected to the processor, wherein the memory stores instructions that cause, when executed, the processor to receive a request for data related to a current state of an article from an electronic device via the communication module, to, when receiving the request for data related to the current state of the article from the electronic device, transmit a request for a search for the current state of the article to at least one external electronic device via the communication module, to receive an article search result from the at least one external electronic device via the communication module, to identify data related to the current state of the article, based on the received article search result, and to transmit the identified data related to the current state of the article to the electronic device via the communication module.

According to various embodiments of the present invention, an article management method of an electronic device may comprise operations of determining whether at least one predetermined article management condition occurs; when the article management condition occurs, searching for a signal transmitted by at least one signal transmission device and receiving the signal from the at least one signal transmission device which transmits the signal; constructing a list of articles corresponding to the article management condition, based on a database which contains data on articles and is stored in at least one of the memory and at least one external electronic device; and storing the constructed list of articles corresponding to the article management condition in the electronic device and the at least one external electronic device.

According to various embodiments of the present invention, the electronic device can prevent unnecessary power consumption by identifying the occurrence of a condition related to article management and then performing a function related to the article management.

According to various embodiments of the present invention, the electronic device can dynamically construct a list of articles by using at least one of various article management conditions, weather-related data, and schedule-related data.

In addition, according to various embodiments of the present invention, the electronic device can provide, by using the server, the user with a current state of an article which is not owned by the user.

### BRIEF DESCRIPTION OF THE DRAWINGS

FIG. 1 is a block diagram illustrating an electronic device in a network environment according to various embodiments.

FIG. 2 is a block diagram of an electronic device according to various embodiments.

FIG. 3 is a block diagram of a program module according to various embodiments.

FIG. 4 is a flow diagram illustrating a method for outputting a notification about an omitted article in an article management method of an electronic device according to various embodiments of the present invention.

FIG. 5 is a flow diagram illustrating a method for constructing a list of articles corresponding to an article management condition by using at least one of weather-related data and schedule-related data in connection with the article management method, shown in FIG. 4, of the electronic device according to various embodiments of the present invention.

FIG. 6A is an exemplary view showing an article list constructed by an electronic device according to various embodiments of the present invention, FIG. 6B is an exemplary view showing an article list constructed using weather-related data by an electronic device according to various embodiments of the present invention, and FIG. 6C is an exemplary view showing an article list constructed using schedule-related data by an electronic device according to various embodiments of the present invention.

FIG. 7 is a flow diagram illustrating a method for adding data for an article to a database in response to a user input in an article management method of an electronic device according to various embodiments of the present invention.

FIG. 8 is a flow diagram illustrating a method for adding data for an article to a database on the basis of an article addition condition in an article management method of an electronic device according to various embodiments of the present invention.

FIG. 9 is a flow diagram illustrating a method for providing data related to the location of an article in an article management method of an electronic device according to various embodiments of the present invention.

FIG. 10 is a flow diagram illustrating a method for transmitting data related to the current state of an article to an electronic device in an article management method of a server according to various embodiments of the present invention.

### DETAILED DESCRIPTION

Hereinafter, various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals. The terms of a singular form may include plural forms unless otherwise specified. In this disclosure, the expressions “A or B”, “at least one of A or/and B”, or “one or more of A or/and B”, and the like may include any and all combinations of one or more of the associated listed items. The terms, such as “first”, “second”, and the like may be used to refer to various elements regardless of the order and/or the priority and to distinguish the relevant elements from other elements, but do not limit the elements. When an element (e.g., a first element) is referred to as being “(operatively or communicatively) coupled with/to” or “connected to” another element (e.g., a second element), the element may be directly coupled with/to or connected to the other element or an intervening element (e.g., a third element) may be present.

According to the situation, the expression “configured to” used in this disclosure may be used as, for example, the expression “suitable for”, “having the capacity to”, “adapted to”, “made to”, “capable of”, or “designed to” in hardware or software. The expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

An electronic device according to various embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, media boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, drones, automatic teller's machines (ATMs), points of sales (POSs) of stores, or interne of things (e.g., light bulbs, various sensors, sprinkler devices, fire alarms, thermostats, street lamps, toasters, exercise equipment, hot water tanks, heaters, boilers, and the like). According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be a flexible electronic device or a combination of two or more above-described devices. Furthermore, an electronic device according to an embodiment of this disclosure may not be limited to the above-described electronic devices. In this disclosure, the term “user” may refer to a person who uses an electronic device or may refer to a device (e.g., an artificial intelligence electronic device) that uses the electronic device.

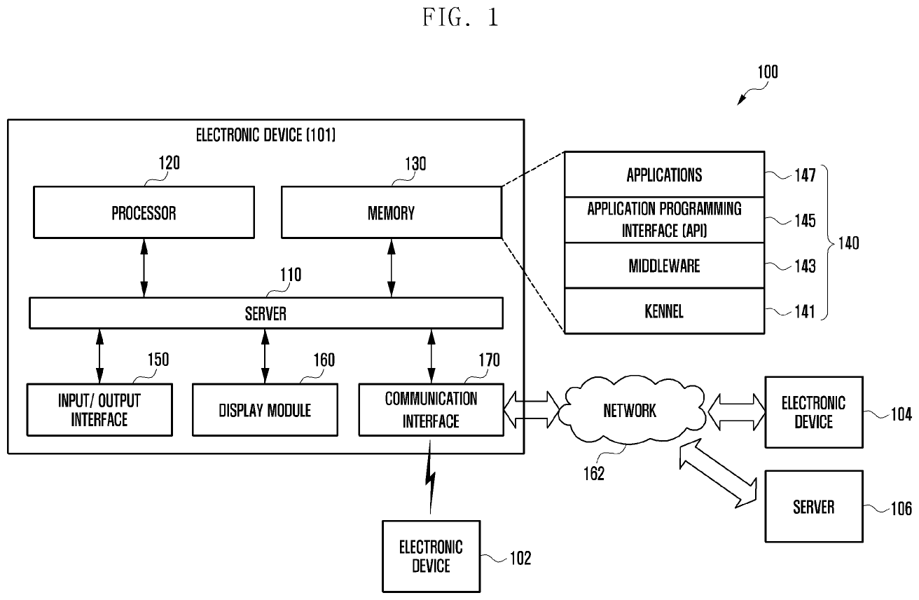

Referring to FIG. 1, according to various embodiments, an electronic device 101 in a network environment is described. The electronic device 101 may include a bus 110, a processor 120, a memory 130, an input/output interface 150, a display 160, and a communication interface 170. According to an embodiment, the electronic device 101 may not include at least one of the above-described elements or may further include other element(s). The bus 110 may interconnect the above-described elements 110 to 170 and may include a circuit for conveying communications (e.g., a control message and/or data) among the above-described elements. The processor 120 may include one or more of a central processing unit (CPU), an application processor (AP), or a communication processor (CP). For example, the processor 120 may perform an arithmetic operation or data processing associated with control and/or communication of at least other elements of the electronic device 101.

The memory 130 may include a volatile and/or nonvolatile memory. For example, the memory 130 may store instructions or data associated with at least one other element(s) of the electronic device 101. According to an embodiment, the memory 130 may store software and/or a program 140. The program 140 may include, for example, a kernel 141, a middleware 143, an application programming interface (API) 145, and/or an application program (or “an application”) 147. At least a part of the kernel 141, the middleware 143, or the API 145 may be referred to as an “operating system (OS)”. For example, the kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete elements of the electronic device 101 so as to control or manage system resources.

The middleware 143 may perform, for example, a mediation role such that the API 145 or the application program 147 communicates with the kernel 141 to exchange data. Furthermore, the middleware 143 may process one or more task requests received from the application program 147 according to a priority. For example, the middleware 143 may assign the priority, which makes it possible to use a system resource (e.g., the bus 110, the processor 120, the memory 130, or the like) of the electronic device 101, to at least one of the application program 147 and may process the one or more task requests. The API 145 may be an interface through which the application program 147 controls a function provided by the kernel 141 or the middleware 143, and may include, for example, at least one interface or function (e.g., a command or an instruction) for a file control, a window control, image processing, a character control, or the like. The input/output interface 150 may transmit an instruction or data input from a user or another external device, to other element(s) of the electronic device 101 or may output an instruction or data, received from other element(s) of the electronic device 101, to a user or another external device.

The display 160 may include, for example, a liquid crystal display (LCD), a light-emitting diode (LED) display, an organic LED (OLED) display, a microelectromechanical systems (MEMS) display, or an electronic paper display. The display 160 may display, for example, various contents (e.g., a text, an image, a video, an icon, a symbol, and the like) to a user. The display 160 may include a touch screen and may receive, for example, a touch, gesture, proximity, or hovering input using an electronic pen or a part of a user's body.

For example, the communication interface 170 may establish communication between the electronic device 101 and an external device (e.g., the first electronic device 102, the second electronic device 104, or the server 106). For example, the communication interface 170 may be connected to the network 162 over wireless communication or wired communication to communicate with the external device (e.g., the second electronic device 104 or the server 106).

For example, the wireless communication may include cellular communication using at least one of long-term evolution (LTE), LTE Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), or the like. The wireless communication may include at least one of wireless fidelity (Wi-Fi), Bluetooth, Bluetooth low energy (BLE), Zigbee, near field communication (NFC), magnetic stripe transmission (MST), radio frequency (RF), a body area network, or the like. According to an embodiment, the wireless communication may include GNSS. The GNSS may be one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”). Hereinafter, in this disclosure, “GPS” and “GNSS” may be interchangeably used. The wired communication may include at least one of, for example, a universal serial bus (USB), a high definition multimedia interface (HDMI), a recommended standard-232 (RS-232), power line communication, a plain old telephone service (POTS), or the like. The network 162 may include at least one of telecommunications networks, for example, a computer network (e.g., LAN or WAN), an Internet, or a telephone network.

Each of the first and second external electronic devices 102 and 104 may be a device of which the type is different from or the same as that of the electronic device 101. According to various embodiments, all or a portion of operations that the electronic device 101 will perform may be executed by another or plural electronic devices (e.g., the first electronic device 102, the second electronic device 104 or the server 106). According to an embodiment, in the case where the electronic device 101 executes any function or service automatically or in response to a request, the electronic device 101 may not perform the function or the service internally, but, alternatively additionally, it may request at least a portion of a function associated with the electronic device 101 at other electronic device (e.g., the electronic device 102 or 104 or the server 106). The other electronic device (e.g., the electronic device 102 or 104 or the server 106) may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

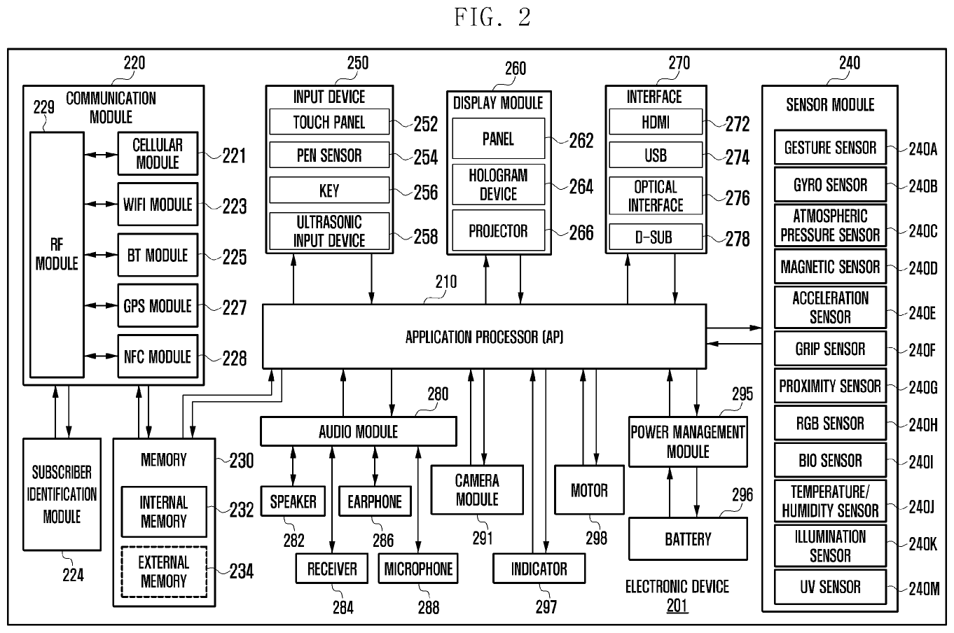

FIG. 2 illustrates a block diagram of an electronic device, according to various embodiments. An electronic device 201 may include, for example, all or a part of the electronic device 101 illustrated in FIG. 1. The electronic device 201 may include one or more processors (e.g., an application processor (AP)) 210, a communication module 220, a subscriber identification module 224, a memory 230, a sensor module 240, an input device 250, a display module 260, an interface 270, an audio module 280, a camera module 291, a power management module 295, a battery 296, an indicator 297, and a motor 298. For example, the processor 210 may be implemented with a System on Chip (SoC). According to an embodiment, the processor 210 may further include a graphic processing unit (GPU) and/or an image signal processor. The processor 210 may include at least a part (e.g., a cellular module 221) of elements illustrated in FIG. 2. The processor 210 may load an instruction or data, which is received from at least one of other elements (e.g., a nonvolatile memory), into a volatile memory and process the loaded instruction or data. The processor 210 may store result data in the nonvolatile memory.

The communication module 220 may be configured the same as or similar to the communication interface 170 of FIG. 1. The communication module 220 may include the cellular module 221, a Wi-Fi module 223, a Bluetooth (BT) module 225, a GNSS module 227, a near field communication (NFC) module 228, and a radio frequency (RF) module 229. The cellular module 221 may provide, for example, voice communication, video communication, a character service, an Internet service, or the like over a communication network. According to an embodiment, the cellular module 221 may perform discrimination and authentication of the electronic device 201 within a communication network by using the subscriber identification module (e.g., a SIM card) 224. According to an embodiment, the cellular module 221 may perform at least a portion of functions that the processor 210 provides. According to an embodiment, the cellular module 221 may include a communication processor (CP). According to an embodiment, at least a part (e.g., two or more) of the cellular module 221, the Wi-Fi module 223, the BT module 225, the GNSS module 227, or the NFC module 228 may be included within one Integrated Circuit (IC) or an IC package. For example, the RF module 229 may transmit and receive a communication signal (e.g., an RF signal). For example, the RF module 229 may include a transceiver, a power amplifier module (PAM), a frequency filter, a low noise amplifier (LNA), an antenna, or the like. According to another embodiment, at least one of the cellular module 221, the Wi-Fi module 223, the BT module 225, the GNSS module 227, or the NFC module 228 may transmit and receive an RF signal through a separate RF module. The subscriber identification module 224 may include, for example, a card and/or embedded SIM that includes a subscriber identification module and may include unique identify information (e.g., integrated circuit card identifier (ICCID)) or subscriber information (e.g., international mobile subscriber identity (IMSI)).

The memory 230 (e.g., the memory 130) may include an internal memory 232 or an external memory 234. For example, the internal memory 232 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD). The external memory 234 may include a flash drive such as compact flash (CF), secure digital (SD), micro secure digital (Micro-SD), mini secure digital (Mini-SD), extreme digital (xD), a multimedia card (MMC), a memory stick, or the like. The external memory 234 may be operatively and/or physically connected to the electronic device 201 through various interfaces.

The sensor module 240 may measure, for example, a physical quantity or may detect an operation state of the electronic device 201. The sensor module 240 may convert the measured or detected information to an electric signal. For example, the sensor module 240 may include at least one of a gesture sensor 240A, a gyro sensor 240B, a barometric pressure sensor 240C, a magnetic sensor 240D, an acceleration sensor 240E, a grip sensor 240F, the proximity sensor 240G, a color sensor 240H (e.g., red, green, blue (RGB) sensor), a biometric sensor 240I, a temperature/humidity sensor 240J, an illuminance sensor 240K, or an UV sensor 240M. Although not illustrated, additionally or generally, the sensor module 240 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one or more sensors included therein. According to an embodiment, the electronic device 201 may further include a processor that is a part of the processor 210 or independent of the processor 210 and is configured to control the sensor module 240. The processor may control the sensor module 240 while the processor 210 remains at a sleep state.

The input device 250 may include, for example, a touch panel 252, a (digital) pen sensor 254, a key 256, or an ultrasonic input unit 258. For example, the touch panel 252 may use at least one of capacitive, resistive, infrared and ultrasonic detecting methods. Also, the touch panel 252 may further include a control circuit. The touch panel 252 may further include a tactile layer to provide a tactile reaction to a user. The (digital) pen sensor 254 may be, for example, a part of a touch panel or may include an additional sheet for recognition. The key 256 may include, for example, a physical button, an optical key, or a keypad. The ultrasonic input device 258 may detect (or sense) an ultrasonic signal, which is generated from an input device, through a microphone (e.g., a microphone 288) and may check data corresponding to the detected ultrasonic signal.

The display module 260 (e.g., the display 160) may include a panel 262, a hologram device 264, a projector 266, and/or a control circuit for controlling the panel 262, the hologram device 264, or the projector 266. The panel 262 may be implemented, for example, to be flexible, transparent or wearable. The panel 262 and the touch panel 252 may be integrated into a single module. According to an embodiment, the panel 262 may include a pressure sensor (or force sensor) that measures the intensity of touch pressure by a user. The pressure sensor may be implemented integrally with the touch panel 252, or may be implemented as at least one sensor separately from the touch panel 252. The hologram device 264 may display a stereoscopic image in a space using a light interference phenomenon. The projector 266 may project light onto a screen so as to display an image. For example, the screen may be arranged in the inside or the outside of the electronic device 201. The interface 270 may include, for example, a high-definition multimedia interface (HDMI) 272, a universal serial bus (USB) 274, an optical interface 276, or a D-subminiature (D-sub) 278. The interface 270 may be included, for example, in the communication interface 170 illustrated in FIG. 1. Additionally or generally, the interface 270 may include, for example, a mobile high definition link (MHL) interface, a SD card/multi-media card (MMC) interface, or an infrared data association (IrDA) standard interface.

The audio module 280 may convert a sound and an electric signal in dual directions. At least a part of the audio module 280 may be included, for example, in the input/output interface 150 illustrated in FIG. 1. The audio module 280 may process, for example, sound information that is input or output through a speaker 282, a receiver 284, an earphone 286, or the microphone 288. For example, the camera module 291 may shoot a still image or a video. According to an embodiment, the camera module 291 may include at least one or more image sensors (e.g., a front sensor or a rear sensor), a lens, an image signal processor (ISP), or a flash (e.g., an LED or a xenon lamp). The power management module 295 may manage, for example, power of the electronic device 201. According to an embodiment, a power management integrated circuit (PMIC), a charger IC, or a battery or fuel gauge may be included in the power management module 295. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, a rectifier, or the like. The battery gauge may measure, for example, a remaining capacity of the battery 296 and a voltage, current or temperature thereof while the battery is charged. The battery 296 may include, for example, a rechargeable battery and/or a solar battery.

The indicator 297 may display a specific state of the electronic device 201 or a part thereof (e.g., the processor 210), such as a booting state, a message state, a charging state, and the like. The motor 298 may convert an electrical signal into a mechanical vibration and may generate the following effects: vibration, haptic, and the like. The electronic device 201 may include a processing device (e.g., a GPU) for supporting a mobile TV. The processing device for supporting the mobile TV may process media data according to the standards of digital multimedia broadcasting (DMB), digital video broadcasting (DVB), MediaFLO™, or the like. Each of the above-mentioned elements of the electronic device according to various embodiments of the present disclosure may be configured with one or more components, and the names of the elements may be changed according to the type of the electronic device. In various embodiments, some elements of the electronic device (e.g., the electronic device 201) may be omitted or other additional elements may be added. Furthermore, some of the elements of the electronic device may be combined with each other so as to form one entity, so that the functions of the elements may be performed in the same manner as before the combination.

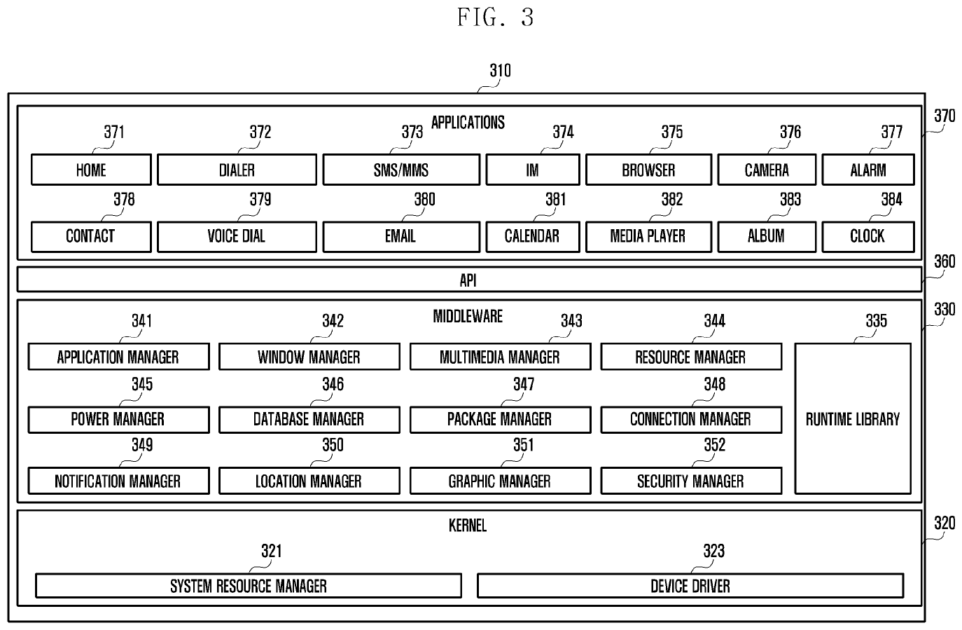

FIG. 3 illustrates a block diagram of a program module, according to various embodiments. According to an embodiment, a program module 310 (e.g., the program 140) may include an operating system (OS) to control resources associated with an electronic device (e.g., the electronic device 101), and/or diverse applications (e.g., the application program 147) driven on the OS. The OS may be, for example, Android™, iOS™, Windows™, Symbian™, Tizen™, or Bada™. The program module 310 may include a kernel 320 (e.g., the kernel 141), a middleware 330 (e.g., the middleware 143), an application programming interface (API) 360 (e.g., the API 145), and/or an application 370 (e.g., the application program 147). At least a portion of the program module 310 may be preloaded on an electronic device or may be downloadable from an external electronic device (e.g., the first electronic device 102, the second electronic device 104, the server 106, or the like).

The kernel 320 (e.g., the kernel 141) may include, for example, a system resource manager 321 or a device driver 323. The system resource manager 321 may control, allocate, or retrieve system resources. According to an embodiment, the system resource manager 321 may include a process managing unit, a memory managing unit, a file system managing unit, or the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver. The middleware 330 may provide, for example, a function that the application 370 needs in common, or may provide diverse functions to the application 370 through the API 360 to allow the application 370 to efficiently use limited system resources of the electronic device. According to an embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include, for example, a library module that is used by a compiler to add a new function through a programming language while the application 370 is being executed. The runtime library 335 may perform input/output management, memory management, or capacities about arithmetic functions. The application manager 341 may manage, for example, a life cycle of at least one application of the application 370. The window manager 342 may manage a graphic user interface (GUI) resource that is used in a screen. The multimedia manager 343 may identify a format necessary for playing diverse media files, and may perform encoding or decoding of media files by using a codec suitable for the format. The resource manager 344 may manage resources such as a memory space or source code of the application 370. The power manager 345 may manage a battery or power, and may provide power information for an operation of an electronic device. According to an embodiment, the power manager 345 may operate with a basic input/output system (BIOS). The database manager 346 may generate, search for, or modify database that is to be used in the application 370. The package manager 347 may install or update an application that is distributed in the form of package file.

The connectivity manager 348 may manage, for example, wireless connection. The notification manager 349 may provide an event, for example, arrival message, appointment, or proximity notification to a user. For example, the location manager 350 may manage location information about an electronic device. The graphic manager 351 may manage a graphic effect that is provided to a user, or manage a user interface relevant thereto. The security manager 352 may provide, for example, system security or user authentication. According to an embodiment, the middleware 330 may include a telephony manager for managing a voice or video call function of the electronic device or a middleware module that combines diverse functions of the above-described elements. According to an embodiment, the middleware 330 may provide a module specialized to each OS kind to provide differentiated functions. Additionally, the middleware 330 may dynamically remove a part of the preexisting elements or may add new elements thereto. The API 360 may be, for example, a set of programming functions and may be provided with a configuration that is variable depending on an OS. For example, in the case where an OS is the android or the iOS, it may provide one API set per platform. In the case where an OS is the tizen, it may provide two or more API sets per platform.

The application 370 may include, for example, applications such as a home 371, a dialer 372, an SMS/MMS 373, an instant message (IM) 374, a browser 375, a camera 376, an alarm 377, a contact 378, a voice dial 379, an e-mail 380, a calendar 381, a media player 382, an album 383, a watch 384, health care (e.g., measuring an exercise quantity, blood sugar, or the like) or offering of environment information (e.g., information of barometric pressure, humidity, temperature, or the like). According to an embodiment, the application 370 may include an information exchanging application to support information exchange between an electronic device and an external electronic device. The information exchanging application may include, for example, a notification relay application for transmitting specific information to an external electronic device, or a device management application for managing the external electronic device. For example, the notification relay application may include a function of transmitting notification information, which arise from other applications, to an external electronic device or may receive, for example, notification information from an external electronic device and provide the notification information to a user. The device management application may install, delete, or update for example, a function (e.g., turn-on/turn-off of an external electronic device itself (or a part of components) or adjustment of brightness (or resolution) of a display) of the external electronic device which communicates with the electronic device, and an application running in the external electronic device. According to an embodiment, the application 370 may include an application (e.g., a health care application of a mobile medical device) that is assigned in accordance with an attribute of an external electronic device. According to an embodiment, the application 370 may include an application that is received from an external electronic device. At least a portion of the program module 310 may be implemented by software, firmware, hardware (e.g., the processor 210), or a combination (e.g., execution) of two or more thereof, and may include modules, programs, routines, sets of instructions, processes, or the like for performing one or more functions.

The “module” used in this document may include a unit including hardware, software or firmware and may be interchangeably used with a term, for example, logic, a logical block, a part or a circuit. The “module” may be an integrated part, a minimum unit to perform one or more functions, or a part thereof. The “module” may be implemented mechanically or electronically, and may include an application-specific integrated circuit (ASIC) chip, field-programmable gate arrays (FPGAs) or a programmable logic device which performs some operations and which has been known or is to be developed, for example. At least some of a device (e.g., modules or functions thereof) or method (e.g., operations) according to various embodiments may be implemented as instructions stored in a computer-readable storage medium (e.g., the memory 130) in the form of a program module. If the instructions are executed by a processor (e.g., the processor 120), the processor may perform functions corresponding to the instructions. The computer-readable storage medium may include a hard disk, a floppy disk, magnetic media (e.g., magnetic tape), optical media (e.g., CD-ROM), a DVD, magneto-optical media (e.g., a floptical disk), and embedded memory. The instructions may include code generated by a compiler or code executable by an interpreter. The module or program module according to various embodiments may include at least one of the aforementioned elements, may omit some of the elements or may further include other elements. Operations performed by the module, program module or other elements according to various embodiments may be executed in a sequential, parallel, repetitive or heuristic manner or at least some operations may be executed in a different sequence or omitted or may further include other operations.

According to various embodiments of the present invention, an electronic device comprises a display; a communication module supporting short-range communication; a processor electrically connected to the display and the communication module; and a memory electrically connected to the processor, wherein the memory may store instructions that cause, when executed, the processor to determine whether at least one predetermined article management condition occurs, to, when the article management condition occurs, control the communication module to search for a signal transmitted by at least one signal transmission device and to receive the signal from the at least one signal transmission device which transmits the signal, to construct a list of articles corresponding to the article management condition, based on a database which contains data on articles and is stored in at least one of the memory and at least one external electronic device, and to store the constructed list of articles corresponding to the article management condition in the memory and the at least one external electronic device.

In the electronic device according to various embodiments of the present invention, the article management condition may be set based on at least one of date-related data, day-related data, time-related data, short-range wireless communication data, and GPS coordinate data.

In the electronic device according to various embodiments of the present invention, the instructions may cause the processor to construct a list of articles related to the received signal, to compare the list of articles related to the received signal with the list of articles corresponding to the article management condition, to determine that an article which is contained in the list of articles corresponding to the article management condition and is not contained in the list of articles related to the received signal is a missed article, and to output a notification about the missed article when the missed article is included in the list of articles corresponding to the article management condition.

In the electronic device according to various embodiments of the present invention, the instructions may cause the processor to, when it is determined that the article management condition occurs, retrieve data on an article related to the article management condition in the database, and to construct the list of articles corresponding to the article management condition, based on the data on articles retrieved from the database.

In the electronic device according to various embodiments of the present invention, the instructions may cause the processor to, when the article related to the received signal is not included in the list of articles corresponding to the article management condition, check whether the data on articles related to the received signal is included in the database, to, when the data on articles related to the received signal is included in the database, request a user input for performing a function of adding at least one of an article name, an article property, and the article management condition to the data on articles related to the received signal, and to, when the data on articles related to the received signal is not included in the database, request a user input for performing a function of generating the data on articles related to the received signal.

In the electronic device according to various embodiments of the present invention, the instructions may cause the processor to, when an article related to the received signal is not included in the list of articles corresponding to the article management condition, check whether data on the article related to the received signal is included in the database, to, when the data on the article related to the received signal is not included in the database, determine whether the article addition condition is satisfied, and to, when the article addition condition related to the received signal is satisfied, add the data on the article related to the received signal to the database.

In the electronic device according to various embodiments of the present invention, the data on articles may include an article property, and the instructions may cause the processor to identify at least one of weather-related data and schedule-related data, to check whether data on an article related to at least one of the weather-related data and the schedule-related data is included in the database, and to, when the data on an article related to at least one of the weather-related data and the schedule-related data is included in the database, add the article of the data on an article related to at least one of the weather-related data and the schedule-related data to the list of articles corresponding to the article management condition.

In the electronic device according to various embodiments of the present invention, the instructions may cause the processor to store at least one of the list of articles related to the received signal, time-related data, and the article management condition in at least one of the memory and the at least one external electronic device, to receive a user input requesting data related to a location of an article, and to identify the data related to the location of an article corresponding to the user input by using the list of articles related to the received signal and at least one of the time-related data and the article management condition.

According to various embodiments of the present invention, a server may comprise a communication module; a processor electrically connected to the communication module; and a memory electrically connected to the processor, wherein the memory stores instructions that cause, when executed, the processor to receive a request for data related to a current state of an article from an electronic device via the communication module, to, when receiving the request for data related to the current state of the article from the electronic device, transmit a request for a search for the current state of the article to at least one external electronic device via the communication module, to receive an article search result from the at least one external electronic device via the communication module, to identify data related to the current state of the article, based on the received article search result, and to transmit the identified data related to the current state of the article to the electronic device via the communication module.

In the server according to various embodiments of the present invention, the instructions may cause the processor to, when data on the article is stored in the memory, transmit the stored data on the article to the external electronic device via the communication module, and to, when the data on the article is not stored in the memory, request, via the communication module, the electronic device to transmit the data on the article.

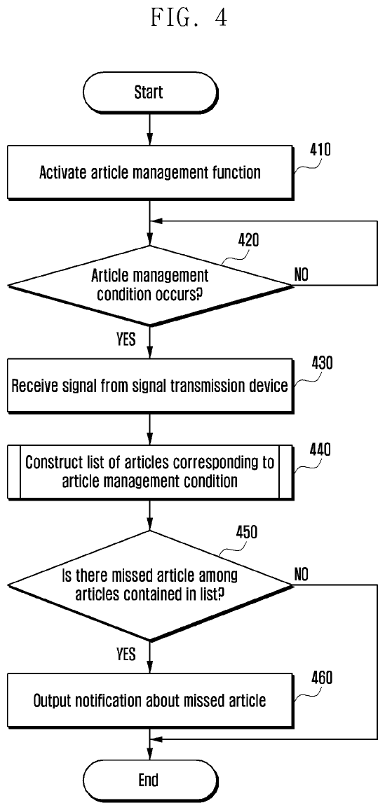

FIG. 4 is a flow diagram illustrating a method for outputting a notification about an omitted article in an article management method of an electronic device according to various embodiments of the present invention.

According to various embodiments of the present invention, the electronic device 201 may activate, at operation 410, a function of managing an article in response to a user input or based on predetermined data. For example, when an input of activating an article management function is received directly from the user, the article management function may be activated. In addition, for example, the electronic device 201 may be set to activate the article management function when powered on, and/or based on at least one of date, day of the week, and time. For example, the electronic device 201 may be set to activate the article management function at a predetermined time (e.g., time to leave home for work), and also set to do not activate the article management function on an off day even though the predetermined time arrives. Further, the electronic device 201 may activate the article management function, based on short-range communication related data, GPS coordinate data, or a combination thereof. For example, the electronic device 201 may be set to activate the article management function when the connection between the electronic device 201 and a WiFi access device (or access point) located inside a user's home is released or when the strength of a signal received from the WiFi access device is less than a certain threshold. Further, the electronic device 201 may be set to activate the article management function when receiving a signal from a signal transmission device (e.g., a BLE beacon) located at a certain place (e.g., door) of the user's home. In this case, a signal transmission range of the signal transmission device may be optionally set by the user. Further, the electronic device 201 may be set to activate the article management function when the electronic device 201 is connected to a WiFi access device located inside a user's office. Further, the electronic device 201 may be connected to an on-board diagnostics version 2 (OBD2) device located within a vehicle through Bluetooth. Here, OBD2 denotes a diagnostic and system standard for checking and controlling electric and electronic operating states of a vehicle. In this case, the electronic device 201 may be set to activate the article management function when the OBD2 device is turned on and connected to the electronic device 201.

According to various embodiments of the present invention, the user may optionally set data related to the activation of the article management function in the electronic device 201.

According to various embodiments of the present invention, the application 370 may include an application related to the article management function, and the electronic device 201 may activate the article management function by executing the application related to the article management function.

According to various embodiments of the present invention, at operation 420, the electronic device 201 may determine whether a condition related to article management (hereinafter, “article management condition”) occurs. Here, the article management condition may mean a condition necessary for the electronic device 201 to execute the management of articles when the article management function of the electronic device 201 is activated. According to various embodiments of the present invention, the article management condition may be optionally set by the user in the electronic device 201, and the electronic device 201 may store data on the article management condition in at least one of the memory 230 and an external electronic device (e.g., the server 106). According to various embodiments, the article management condition may be determined based on at least one or combination of date-related data, day-related data, time-related data, short-range communication related data, and GPS coordinate data, and may be optionally set by the user.

For example, in case where the connection between the electronic device 102 and a WiFi access point (AP) located inside a user's home is released, or in case where the strength of a signal received from the WiFi AP becomes smaller than a certain threshold, this case may be set in the electronic device 201 as the occurrence of the article management condition called “Going out”.

For example, in a specific time zone of a predetermined working day, when the connection between the electronic device 102 and the WiFi AP located inside the user's home is released, or when the strength of a signal received from the WiFi AP is smaller than the threshold, this may be set in the electronic device 201 as the occurrence of the article management condition called “Leaving home for work”. In addition, when the user registers an address of a specific building and/or a company name as a workplace in the electronic device 201, and when the electronic device 201 recognizes repeatedly (e.g., five times or more per week), using location data (e.g., GPS coordinate data), that the user moves to a location corresponding to the registered address and/or company name, the electronic device 201 may determine that the location corresponding to the registered address and/or company name is a position of a user's workplace. Further, when the electronic device 201 recognizes repeatedly (e.g., five times or more per week) that the user moves to the position of the workplace on a certain day of the week and/or in a certain time zone, the electronic device 201 may determine the above day of the week and/or time zone as a user's working day of the weekday and/or time zone and then set this data as at least part of the article management condition of “Leaving home for work”.

For example, the electronic device 201 can be connected to an OBD2 device located inside the vehicle through Bluetooth. In this case, when the OBD2 device is turned on and connected to the electronic device 201, this may be set in the electronic device 201 as the occurrence of the article management condition called “Ride”. In addition, when the OBD2 device is turned off and disconnected from the electronic device 201, this may be set in the electronic device 201 as the occurrence of the article management condition called “Dismount”.

According to various embodiments of the present invention, when it is determined that the article management condition occurs, the electronic device 201 may search for signals transmitted by at least one device transmitting signals (hereinafter referred to as a “signal transmission device”) and receive a signal from the at least one signal transmission device at operation 430. According to various embodiments of the present invention, the signal transmission device may periodically generate a signal, which may contain identification data for the signal transmission device. According to various embodiments of the present invention, the signal transmission device may be attached to an article or may be a component of an article. Although it is described in this disclosure that the signal transmission device is attached to an article, this is exemplary only and not intended to limit the scope of the technology described herein.

For example, a BLE beacon attached to an article may periodically generate a signal that contains unique identification data of the BLE device. In this case, controlling the communication module 220, the electronic device 201 may search for signals generated by the BLE beacon and receive a signal from the BLE beacon. Further, the electronic device 201 may identify a BLE beacon-attached article by distinguishing the BLE beacon attached to the article from the other BLE beacons through the identification data contained in the received signal.

According to various embodiments of the present invention, the electronic device 201 may store in the memory 230 a database containing data on each article. In addition, such data on each article may be uploaded to and stored in an external electronic device (e.g., the server 106). The external electronic device may operate as a cloud server. The data on the article may include at least one of identification data of the signal transmission device related to the article, a name of the article, a property of the article, and a corresponding article management condition. The property of the article may mean the usage characteristics of each article to be considered by the electronic device 201 when a list of articles is constructed.

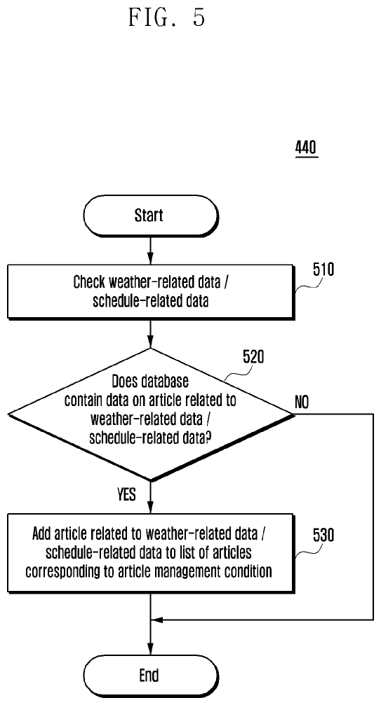

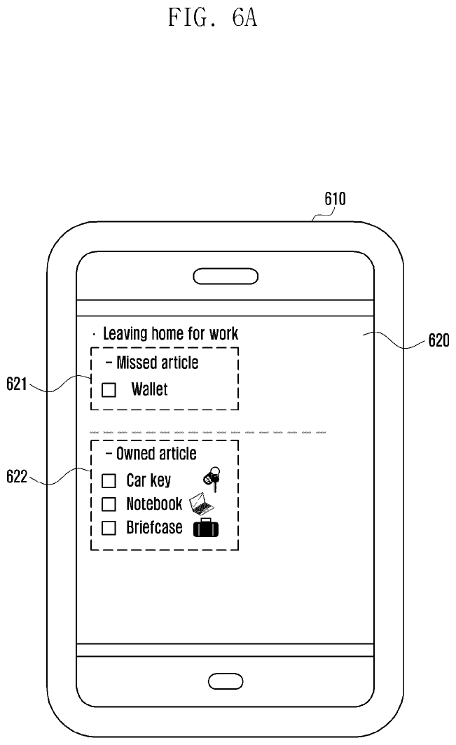

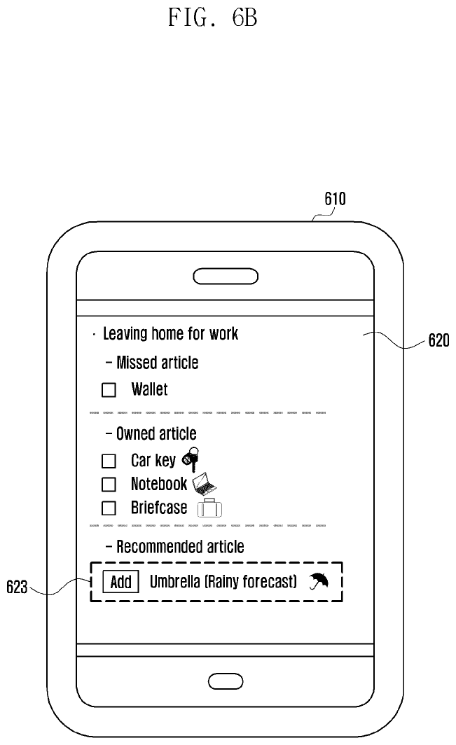

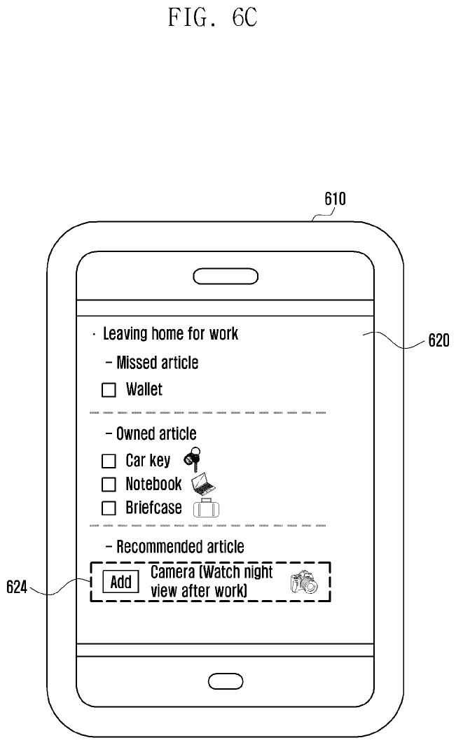

For example, in regard to the properties of the article, the electronic device 201 may consider weather-related data on rain, snow, ultraviolet intensity, concentration of fine dust, or the like, and schedule-related data of the user. For example, in case of an umbrella which is an article related to weather, the properties of the article may be rain, snow, and the like, and in case of a passport which is an article related to a user schedule, the properties of the article may be a business trip, an oversea travel, and the like. A method for constructing a list of articles in consideration of the properties of the articles will be described below with reference to FIGS. 5, 6A, 6B and 6C.

According to various embodiments of the present invention, at operation 440, the electronic device 201 may construct a list of articles corresponding to an article management condition, based on a database that contains data on articles. Here, the list of articles corresponding to the article management condition may mean a list of articles corresponding to data including the article management condition among data contained in the database.

According to various embodiments of the present invention, the electronic device 201 may retrieve data related to the article management condition determined to have occurred from among data on articles contained in the database and then, based on the retrieved data, construct the list of articles corresponding to the article management condition. For example, if data on articles corresponding to the article management condition “Living home for work” are data on a wallet, a briefcase, and a notebook among data on articles contained in the database, the electronic device 201 may construct a list including a wallet, a briefcase, and a notebook as a list of corresponding articles when it is determined that the article management condition “Living home for work” occurs.

According to various embodiments of the present invention, the electronic device 201 may store in the memory 230 the list constructed at operation 440. In addition, the list of articles corresponding to the article management condition may be uploaded to and stored in an external electronic device (e.g., the server 106). The external electronic device may operate as a cloud server. For example, the electronic device 201 may construct a list of articles corresponding to “Living home for work” to include a wallet, a briefcase, and a notebook, and then store the constructed list in at least one of the memory 230 and the server. When it is determined that the article management condition “Living home for work” occurs, the electronic device 201 may use the list of articles corresponding to the article management condition “Living home for work” stored in at least one of the memory 230 and the server.

According to various embodiments of the present invention, regardless of whether the article management condition occurs, the electronic device 201 may construct a list of articles corresponding to the article management condition and store the constructed list in at least one of memory 230 and an external electronic device (e.g., server 106). For example, before determining at operation 420 that the article management condition occurs, the electronic device 201 may retrieve data related to each article management condition from among data on articles contained in the database, and construct a list of articles corresponding to each article management condition. In addition, the electronic device 201 may store the constructed list in at least one of the memory 230 and an external electronic device (e.g., the server 106). Then, when it is determined at operation 420 that the article management condition occurs, the electronic device 201 may use the stored list at operation 440.

According to various embodiments of the present invention, at operation 450, the electronic device 201 may check whether an article related to at least one received signal is included in the list of articles corresponding to the article management condition, and thereby determine that an article irrelevant to any received signal from among articles included in the list is a missed article. For example, the electronic device 201 may recognize identification data of a BLE beacon included in the at least one received signal. In case where the list of articles corresponding to the article management condition includes a wallet, a briefcase, and a notebook, the electronic device 201 may compare the identification data of the BLE beacon with data on a wallet, a briefcase, and a notebook included in the database. If the data on the wallet and the briefcase includes data related to the identification data of the BLE beacon, but if the data on the notebook does not include data related to the identification data of the BLE beacon, the electronic device 201 may determine that the notebook is a missed article.

According to various embodiments of the present invention, the electronic device 201 may construct a list of articles related to the received signal, based on the database. In addition, the electronic device 201 may determine a missed article by comparing the list of articles related to the received signal with the list of articles corresponding to the article management condition. For example, the electronic device 201 may retrieve, from among data contained in the database, data related to the identification data of the BLE beacon recognized from the received signal, and construct a list of articles related to the received signal to include articles on the retrieved data. In this case, the electronic device 201 may compare the list of articles related to the received signal with the list of articles corresponding to the article management condition, and determine that an article that is contained in the list of articles corresponding to the article management condition and is not contained in the list of articles related to the received signal is a missed article.

According to various embodiments of the present invention, the electronic device 201 may store the list of articles related to the received signal in the memory 230 together with at least one of time-related data and the article management condition. In addition, the list of articles related to the received signal may be uploaded to and stored in an external electronic device (e.g., the server 106) together with at least one of the time-related data and the article management condition. The external electronic device may operate as a cloud server. For example, using at least one of the list of articles related to the received signal, a time when the list of articles related to the received signal is constructed, and/or the article management condition, which are stored in at least one of the memory 230 or the external electronic device, the electronic device 201 may know when, under what condition, for which article, the BLE beacon signal is received.

According to various embodiments of the present invention, at operation 460, the electronic device 201 may output a notification about a missed article when the list of articles corresponding to the article management condition includes the missed article.

According to various embodiments of the present invention, the electronic device 201 may output the notification about the missed article to the display module 260, thereby providing data on the missed article to the user. For example, if a wallet, a briefcase, and a notebook are included in the list of articles corresponding to the article management condition, and if the notebook is determined as the missed article, the electronic device 201 may display, on the display module 260, a notification indicating that the wallet and the briefcase are owned articles and the notebook is a missed article.

According to various embodiments of the present invention, the electronic device 201 may output the notification about the missed article through the audio module 280, thereby providing data on the missed article to the user. For example, when a missed article is included in the list of articles corresponding to the article management condition, the electronic device 201 may output a sound signal, e.g., a beep sound, indicating the existence of the missed article through the speaker 282 or the earphone 286.

According to various embodiments, the electronic device may provide the notification about the missed article to the user by using an external electronic device. For example, if a missed article is included in the list of articles corresponding to the article management condition in a state where the electronic device is connected to an external electronic device (e.g., a navigation device) located inside a vehicle, the electronic device may transmit data on the missed article and/or data on the owned article to the external electronic device, and request the external electronic device to display the transmitted data on a display of the external electronic device. Thus, the user can be provided with data on the missed article through the external electronic device as well as the electronic device.

FIG. 5 is a flow diagram illustrating a method for constructing a list of articles corresponding to an article management condition by using at least one of weather-related data and schedule-related data in connection with the article management method, shown in FIG. 4, of the electronic device according to various embodiments of the present invention.

According to various embodiments of the present invention, at operation 510, the electronic device 201 may check at least one of weather-related data and schedule-related data.

According to various embodiments of the present invention, using the application 370, the electronic device 201 may check at least one of the weather-related data and the schedule-related data. For example, the application 370 may include a weather application that provides data related to weather, and the electronic device 201 may recognize data related to a current weather by using the weather application. For example, the application 370 may include a scheduling application that provides data related to a user's schedule, and the electronic device 201 may recognize a user's schedule by using the scheduling application.

According to various embodiments of the present invention, at operation 520, the electronic device 201 may determine whether the database contains data on an article related to at least one of the weather-related data and the schedule-related data. For example, if the electronic device 201 recognizes using the weather application that it is rainy weather, the electronic device may determine whether there is data on an article having a property related to rain in data on articles contained in the database. For example, when the electronic device 201 recognizes using the scheduling application that watching a night view is scheduled after work, and that a camera is necessary for watching a night view, the electronic device may check whether there is data on an article having a name of camera in data on articles contained in the database.

According to various embodiments of the present invention, when the database contains data on an article related to at least one of the weather-related data and the schedule-related data, the electronic device 201 may add, at operation 530, the article related to at least one of the weather-related data and the schedule-related data to the list of articles corresponding to the article management condition. According to various embodiments of the present invention, when the database contains data on an article related to at least one of the weather-related data and the schedule-related data, the electronic device may request a user input for performing a function of adding the article to the list of articles corresponding to the article management condition.

FIG. 6A is an exemplary view showing an article list constructed by an electronic device according to various embodiments of the present invention, FIG. 6B is an exemplary view showing an article list constructed using weather-related data by an electronic device according to various embodiments of the present invention, and FIG. 6C is an exemplary view showing an article list constructed using schedule-related data by an electronic device according to various embodiments of the present invention. Here, the electronic device 610 may be one of the electronic device 101 shown in FIG. 1 or the electronic device 201 shown in FIG. 2.

Referring to FIG. 6A, the electronic device 610 according to various embodiments of the present invention may display, on a display screen 620, data on a currently owned article and/or a missed article. For example, when it is determined that an article management condition called “Leaving home for work” occurs, the electronic device 610 may construct a list of articles corresponding to “Leaving home for work”. If this list of articles includes a wallet, a car key, a notebook, and a briefcase, and if the wallet is a missed article, the electronic device 610 may display, on the display screen 620, data 622 indicating that the car key, the notebook, and the briefcase are currently owned articles, and may also display data 621 indicating that the wallet is a missed article. Alternatively, the electronic device 610 may display only the data 621 indicating the missed article on the display screen 620.

Referring to FIG. 6B, the electronic device 610 according to various embodiments of the present invention may display, on the display screen 620, data on a currently owned article and a missed article. In addition, the electronic device 610 may further display, on the display screen 620, data 621 on an article related to weather. In addition, the electronic device 610 may request a user input for performing a function of adding the weather-related article to the list of articles corresponding to the article management condition.

For example, if a list of articles corresponding to the article management condition called “Leaving home for work” includes a wallet, a car key, a notebook, and a briefcase, and if the wallet is a missed article, the electronic device 610 may display the car key, the notebook, and the briefcase as currently owned articles on the display screen 620, and also display the wallet as a missed article. If the electronic device 610 recognizes using the weather application that the weather is rainy, the electronic device 610 may further display data 623 on an umbrella 620 as a recommended article on the display screen. In addition, for example, the electronic device 610 may provide a user interface for performing a function of adding the umbrella, which is the weather-related article, to the list of articles corresponding to the article management condition “Leaving home for work”. Then, when a user input for adding the umbrella to the list of articles corresponding to “Leaving home for work” is received, the electronic device 610 may add the umbrella to the list of articles corresponding to “Leaving home for work”. In addition, when a user input for adding the umbrella to the list of articles corresponding to “Leaving home for work” is received, the electronic device 610 may provide a user interface that requests a further user input (e.g., a one-time addition, an addition whenever the rainy weather is recognized) associated with the addition of articles.

Referring to FIG. 6C, the electronic device 610 according to various embodiments of the present invention may display, on the display screen 620, data on a currently owned article and a missed article. In addition, the electronic device 610 may further display, on the display screen 620, data 624 on an article related to schedule. In addition, the electronic device 610 may request a user input for performing a function of adding the schedule-related article to the list of articles corresponding to the article management condition.

For example, if a list of articles corresponding to the article management condition called “Leaving home for work” includes a wallet, a car key, a notebook, and a briefcase, and if the wallet is a missed article, the electronic device 610 may display the car key, the notebook, and the briefcase as currently owned articles on the display screen 620, and also display the wallet as a missed article. If a user schedule registered in the scheduling application has watching a night view after work, and if it is recognized that the camera is included in the schedule as an article necessary for watching a night view, the electronic device 610 may further display data 624 on the camera as a recommended article on the display screen 620.

According to various embodiments of the present invention, the electronic device 610 may display the recommended article, based on a user's usage history. For example, if watching a night view after work has been registered as a previous schedule in the scheduling application, and if there is a history of using the camera in the previous schedule (e.g., watching a night view), the electronic device 610 may add the camera as an article required for watching a night view. Then, when it is recognized that a user schedule registered in the scheduling application is set as watching a night view after work, the electronic device 610 may display the data 624 on the camera as a recommended article on the display screen 620, based on the user's usage history.

According to various embodiments of the present invention, the electronic device 610 may provide a user interface for performing a function of adding the camera, which is the schedule-related article, to the list of articles corresponding to the article management condition “Leaving home for work”. Then, when a user input for adding the camera to the list of articles corresponding to “Leaving home for work” is received, the electronic device 610 may add the camera to the list of articles corresponding to “Leaving home for work”. In addition, when a user input for adding the camera to the list of articles corresponding to “Leaving home for work” is received, the electronic device 610 may provide a user interface that requests a further user input (e.g., a one-time addition, an addition whenever the camera is recognized as an article required for a schedule) associated with the addition of articles.

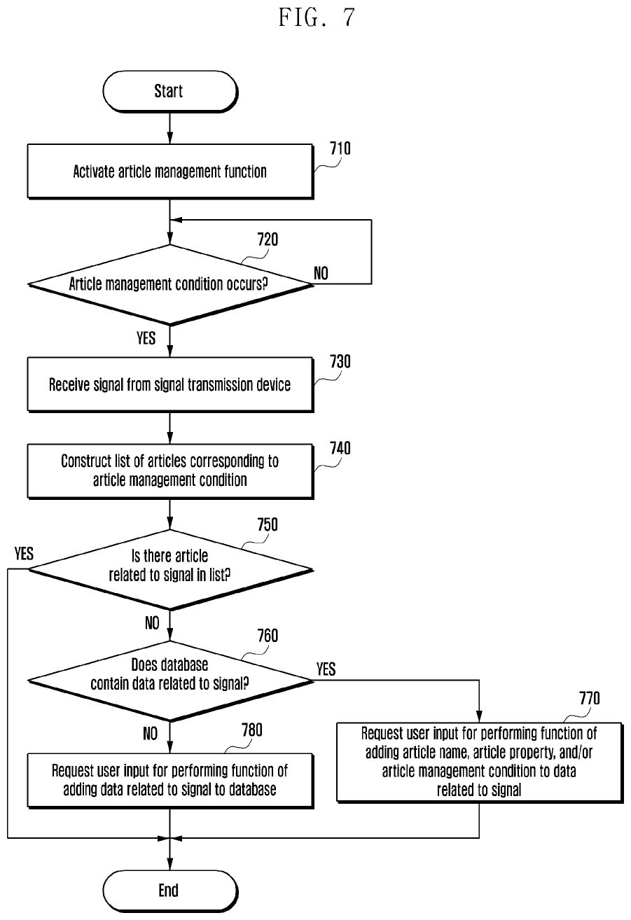

FIG. 7 is a flow diagram illustrating a method for adding data for an article to a database in response to a user input in an article management method of an electronic device according to various embodiments of the present invention. The same descriptions as made above in FIG. 4 will be omitted.

According to various embodiments of the present invention, at operation 710, the electronic device 201 may activate a function of managing articles in response to a user input or settings.

According to various embodiments of the present invention, at operation 720, the electronic device 201 may determine whether an article management condition occurs. According to various embodiments of the present invention, the article management condition may be optionally set by the user in the electronic device 201. The electronic device 201 may store data on the article management condition in at least one of the memory 230 and an external electronic device (e.g., the server 106).

According to various embodiments of the present invention, when it is determined that the article management condition occurs, the electronic device 201 may search for and/or receive, at operation 730, a signal transmitted by a signal transmission device.

According to various embodiments of the present invention, the electronic device 201 may store a database containing data on each article in at least one of the memory 230 and an external electronic device (e.g., the server 106). For example, the data on the article may include at least one of identification data of the signal transmission device related to the article, a name of the article, a property of the article, and a corresponding article management condition.

According to various embodiments of the present invention, at operation 740, the electronic device 201 may construct a list of articles corresponding to the article management condition, based on the database containing data on articles.

According to various embodiments of the present invention, the electronic device 201 may retrieve data related to the article management condition determined to have occurred from among data on articles contained in the database. For example, if the article management condition called “Leaving home for work” occurs, and if data related to the article management condition “Leaving home for work” from among data on articles included in the database is data on a wallet, a briefcase, and a notebook, the electronic device 201 may retrieve, from the database, data on the wallet, the briefcase, and the notebook. Then, based on the retrieved data, the electronic device 201 may construct a list of articles corresponding to the article management condition. For example, the electronic device 201 may construct a list including a wallet, a briefcase, and a notebook as the list of articles corresponding to the article management condition “Leaving home for work”.

According to various embodiments of the present invention, regardless of whether the article management condition occurs, the electronic device 201 may construct a list of articles corresponding to the article management condition and store the constructed list in at least one of memory 230 and an external electronic device (e.g., server 106). For example, before determining at operation 720 that the article management condition occurs, the electronic device 201 may retrieve data related to each article management condition from among data on articles contained in the database, and construct a list of articles corresponding to each article management condition. In addition, the electronic device 201 may store the constructed list in at least one of the memory 230 and an external electronic device (e.g., the server 106). Then, when it is determined at operation 720 that the article management condition occurs, the electronic device 201 may receive the signal from the signal transmission device at operation 730 and use the stored list at operation 740.

According to various embodiments of the present invention, at operation 750, the electronic device 201 may check whether an article related to at least one received signal is included in the list of articles corresponding to the article management condition.

According to various embodiments of the present invention, when an article related to the received signal is not included in the list of articles corresponding to the article management condition, the electronic device 201 may check at operation 760 whether the data related to the received signal is included in the database. For example, by comparing identification data of the received signal, identified at operation 750, with data on articles contained in the database, the electronic device 201 may check whether the database contains data related to the received signal.

According to various embodiments of the present invention, when an article related to the received signal is included in the list of articles corresponding to the article management condition, the electronic device 201 may request, at operation 770, a user input for performing a function of adding an article name, an article property, and/or a corresponding article management condition to data on the article related to the received signal. For example, if the received signal is a signal transmitted by a BLE beacon attached to the notebook, if data having identification data of the BLE beacon attached to the notebook is contained in the database, and if the data does not have an article name, an article property, and/or a corresponding article management condition, the electronic device 201 may provide a user interface for performing a function of adding the article name, the article property, and/or the corresponding article management condition to the data. In addition, the electronic device 201 may request a user input for performing a function of adding the article related to the received signal to the list of articles corresponding to the article management condition. For example, if the list of articles corresponding to the article management condition “Leaving home for work” does not have a notebook, and if the database has data related to the notebook, the electronic device 201 may provide a user interface for performing a function of adding the notebook to the list of articles corresponding to “Leaving home for work”. In this case, if a user input for adding the notebook to the list of articles corresponding to “Leaving home for work” is received, the electronic device 201 may add the notebook to the list of articles constructed at operation 740, and also add “Leaving home for work” as the corresponding article management condition to data related to the notebook.

According to various embodiments of the present invention, when the data related to the received signal is not included in the database, the electronic device 201 may generate data on an article related to the received signal and then request a user input for performing a function of adding the generated data to the database at operation 780. In addition, the electronic device 201 may request a user input for performing a function of adding the article related to the generated data to the list of articles corresponding to the article management condition. For example, if the electronic device 201 receives a signal of a BLE beacon attached to the notebook, and if the database does not contain data related to the signal of the BLE beacon attached to the notebook, the electronic device 201 may provide, through the display module 260, a user interface for performing a function of generating data on the article related to the signal of the BLE beacon attached to the notebook. Then, the user may input at least one of an article name, an article property, and a corresponding article management condition by using the user interface, and the electronic device 201 may generate data including the identification data contained in the signal received from the BLE beacon attached to the notebook, and/or the above user input data on the article name, the article property, and the corresponding article management condition, and add the generated data to the database.

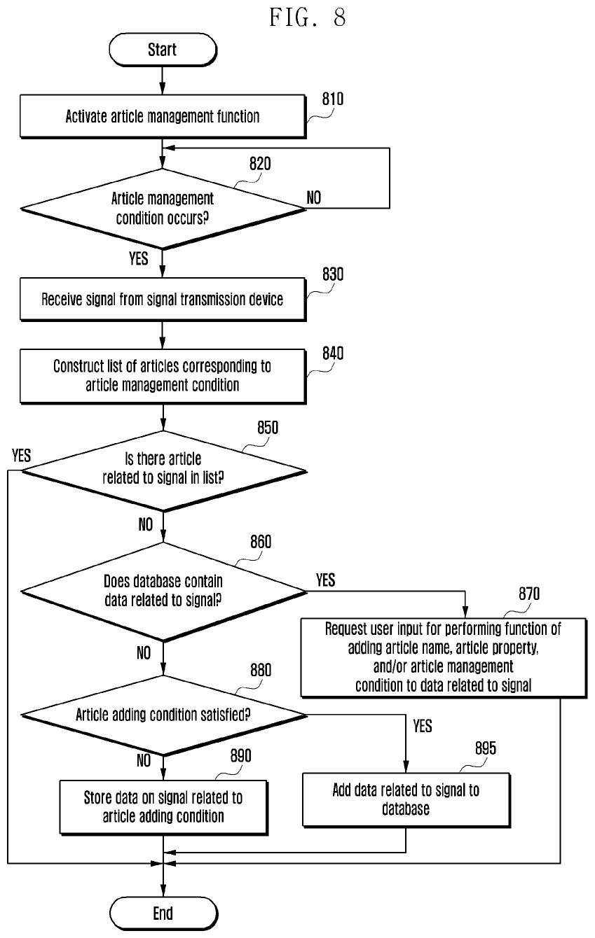

FIG. 8 is a flow diagram illustrating a method for adding data for an article to a database on the basis of an article addition condition in an article management method of an electronic device according to various embodiments of the present invention. The same descriptions as made above in FIGS. 4 and 7 will be omitted.

According to various embodiments of the present invention, at operation 810, the electronic device 201 may activate a function of managing articles in response to a user input or settings.

According to various embodiments of the present invention, at operation 820, the electronic device 201 may determine whether an article management condition occurs. According to various embodiments of the present invention, the article management condition may be optionally set by the user in the electronic device 201. The electronic device 201 may store data on the article management condition in at least one of the memory 230 and an external electronic device (e.g., the server 106).

According to various embodiments of the present invention, when it is determined that the article management condition occurs, the electronic device 201 may search for and/or receive, at operation 830, a signal transmitted by a signal transmission device. According to various embodiments of the present invention, the electronic device 201 may store a database containing data on each article in at least one of the memory 230 and an external electronic device (e.g., the server 106). For example, the data on the article may include at least one of identification data of the signal transmission device related to the article, a name of the article, a property of the article, and a corresponding article management condition.

According to various embodiments of the present invention, at operation 840, the electronic device 201 may construct a list of articles corresponding to the article management condition, based on the database containing data on articles.

According to various embodiments of the present invention, the electronic device 201 may retrieve data related to the article management condition determined to have occurred from among data on articles contained in the database. For example, if the article management condition called “Leaving home for work” occurs, and if data related to the article management condition “Leaving home for work” from among data on articles included in the database is data on a wallet, a briefcase, and a notebook, the electronic device 201 may retrieve, from the database, data on the wallet, the briefcase, and the notebook. Then, based on the retrieved data, the electronic device 201 may construct a list of articles corresponding to the article management condition. For example, the electronic device 201 may construct a list including a wallet, a briefcase, and a notebook as the list of articles corresponding to the article management condition “Leaving home for work”.

According to various embodiments of the present invention, regardless of whether the article management condition occurs, the electronic device 201 may construct a list of articles corresponding to the article management condition and store the constructed list in at least one of memory 230 and an external electronic device (e.g., server 106). For example, before determining at operation 820 that the article management condition occurs, the electronic device 201 may retrieve data related to each article management condition from among data on articles contained in the database, and construct a list of articles corresponding to each article management condition. In addition, the electronic device 201 may store the constructed list in at least one of the memory 230 and an external electronic device (e.g., the server 106). Then, when it is determined at operation 820 that the article management condition occurs, the electronic device 201 may use the stored list at operation 840.

According to various embodiments of the present invention, at operation 850, the electronic device 201 may check whether an article related to at least one received signal is included in the list of articles corresponding to the article management condition.

According to various embodiments of the present invention, when an article related to the received signal is not included in the list of articles corresponding to the article management condition, the electronic device 201 may check at operation 860 whether the data related to the received signal is included in the database.

According to various embodiments of the present invention, when an article related to the received signal is included in the list of articles corresponding to the article management condition, the electronic device 201 may request, at operation 870, a user input for performing a function of adding an article name, an article property, and/or a corresponding article management condition to data on the article related to the received signal. For example, if the received signal is a signal transmitted by a BLE beacon attached to the notebook, if data having identification data of the BLE beacon attached to the notebook is contained in the database, and if the data does not have an article name, an article property, and/or a corresponding article management condition, the electronic device 201 may provide a user interface for performing a function of adding the article name, the article property, and/or the corresponding article management condition to the data.

According to various embodiments of the present invention, when the data related to the received signal is not included in the database, the electronic device 201 may determine at operation 880 whether a condition (hereinafter, “article adding condition) for adding data on an article related to the received signal to the database is satisfied. Here, the article adding condition may mean a condition required for adding data on an article related to a signal received by the electronic device 201 to the database when data on the article to which the signal transmission device generating the signal is attached is not included in the database. According to various embodiments of the present invention, the article adding condition may be optionally set by the user in the electronic device 201, and the electronic device 201 may store data on the article adding condition to the memory 230 and an external electronic device (e.g., the server 106). For example, if the electronic device 201 receives a signal of the same BLE beacon for three days under the article management condition of “Leaving home for work”, this may be set as satisfying the article adding condition in the electronic device 201.

According to various embodiments of the present invention, when the article adding condition related to the received signal is not satisfied, the electronic device 201 may store at operation 890 data on the received signal related to the article adding condition to the memory 230 and the external electronic device (e.g., the server 106).

For example, if the article adding condition is three times reception of the same signal, and if the electronic device 201 first receives a signal from a BLE beacon, the electronic device 201 may store data on receiving the signal from the BLE beacon once in at least one of the memory 230 and the external electronic device (e.g., the server 106). Then, when receiving the signal from the BLE beacon again, the electronic device 201 may use the data stored in at least one of the memory 230 and the external electronic device (e.g., the server 106).

According to various embodiments of the present invention, when the article adding condition related to the received signal is satisfied, the electronic device 201 may add at operation 895 data on the article related to the received signal to the database.

For example, when the same signal is received three times under the same article management condition, this may be set in the electronic device 201 as satisfying the article adding condition. If the article management condition of “Leaving home for work” occurs for three days, and if the electronic device 201 receives a signal of a BLE beacon attached to a tablet PC once for three days when the article management condition of “Leaving home for work” occurs, the signal of the BLE beacon attached to the tablet PC may satisfy the article adding condition set in the electronic device 201. Thus, the electronic device 201 may add data on the tablet PC, which is an article related to the BLE beacon signal satisfying the article adding condition, to the database. On the other hand, the electronic device 201 may recognize only the identification data and the article management condition included in the received signal, for example, thereby adding data on the article to the database without the article name and the article property.

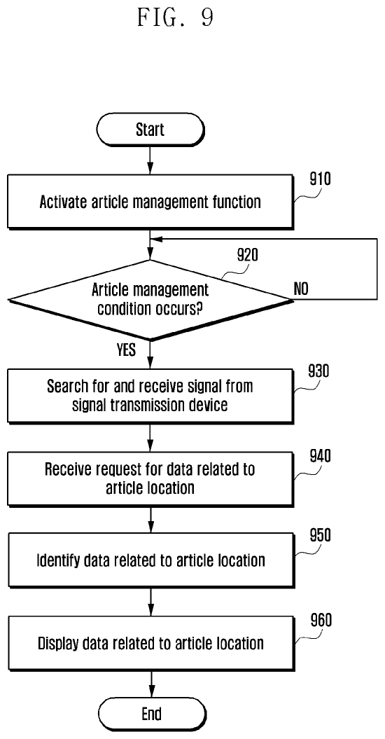

FIG. 9 is a flow diagram illustrating a method for providing data related to the location of an article in an article management method of an electronic device according to various embodiments of the present invention. The same descriptions as made above in FIGS. 4 to 8 will be omitted.

According to various embodiments of the present invention, at operation 910, the electronic device (e.g., 201) may activate a function of managing articles in response to a user input or settings. For example, the electronic device may include an application capable of performing the article management function and execute this application to activate the article management function.

According to various embodiments of the present invention, at operation 920, the electronic device 201 may determine whether an article management condition occurs. According to various embodiments of the present invention, the article management condition may be optionally set by the user in the electronic device 201. The electronic device 201 may store data on the article management condition in at least one of the memory 230 and an external electronic device (e.g., the server 106).

According to various embodiments of the present invention, when it is determined that the article management condition occurs, the electronic device 201 may search for and/or receive, at operation 930, a signal transmitted by a signal transmission device.

According to various embodiments of the present invention, the electronic device 201 may construct a list of articles related to the received signal, based on database. In addition, the electronic device may store the list of articles related to the received signal in the memory together with time-related data and/or the article management condition. For example, if the article management condition of “Leaving home for work” occurs at 8 am, the electronic device may receive a signal from a signal transmission device attached to an article (e.g., a wallet, a notebook, a key) held by the user. Also, the electronic device may construct a list of articles related to the received signal, based on data on a wallet, a notebook, and a key included in the database. Also, the electronic device may store the constructed list of articles in the memory together with the time-related data “8 am” and/or the article management condition “Leaving home for work”. On the other hand, the electronic device may upload and store the constructed list of articles together with the time-related data and/or the article management condition to and in an external electronic device (e.g., the server 106). The external electronic device may operate as a cloud server.

According to various embodiments of the present invention, at operation 940, the electronic device may receive a user input requesting data related to the location of an article. For example, the electronic device may display, on the display (e.g., 260), a user interface that provides a list of articles contained in the database, and may receive a user input of selecting a particular article. Alternatively, the electronic device may display on the display a user interface of providing a function of searching for articles contained in the database, and may receive a user input of retrieving a particular article.

According to various embodiments of the present invention, at operation 950, the electronic device may identify data related to the location of the article corresponding to the user input by using the list of articles related to the received signal, the time-related data, and/or the article management condition, which are stored in at least one of the memory and the external electronic device. For example, if a user input requesting data related to the location of a wallet is received, the electronic device may check whether the wallet is included in the list of articles related to the received signal stored in at least one of the memory and the external electronic device. In addition, the electronic device may further identify the time-related data “8 am” and the article management condition “Leaving home for work” which are stored together with the list of articles including the wallet. Thus, when the article management condition “Leaving home for work” occurs at “8 am”, the electronic device may determine that the user has a wallet. On the other hand, if two or more lists of articles related to the received signal including an article corresponding to a user input are stored in at least one of the memory and the external electronic device, the electronic device may identify, by using the time-related data stored together with the lists, the order in which the two or more lists are stored. In addition, using the list of articles related to the received signal, the time-related data, and/or the article management condition stored in at least one of the memory and the external electronic device, the electronic device may check the details about the reception of the signal of the signal transmission device attached to a user's article. For example, if a list of articles including a wallet, the time-related data “8 am”, and/or the article management condition “Leaving home for work” are stored in at least one of the memory and the external electronic device, and if a list of articles including no wallet, the time-related data “6 pm”, and/or the article management condition “Leaving office after work” are stored in at least one of the memory and the external electronic device, the electronic device may determine that the user holds a wallet when the article management condition “Leaving home for work” occurs at “8 am”, and that the user does not hold a wallet when the article management condition “Leaving office after work” occurs at “5 pm”.

According to various embodiments of the present invention, at operation 960, the electronic device may provide the data related to the location of the article corresponding to the user input to the user. For example, the electronic device may display, on the display, data related to the location of the article corresponding to the user input.

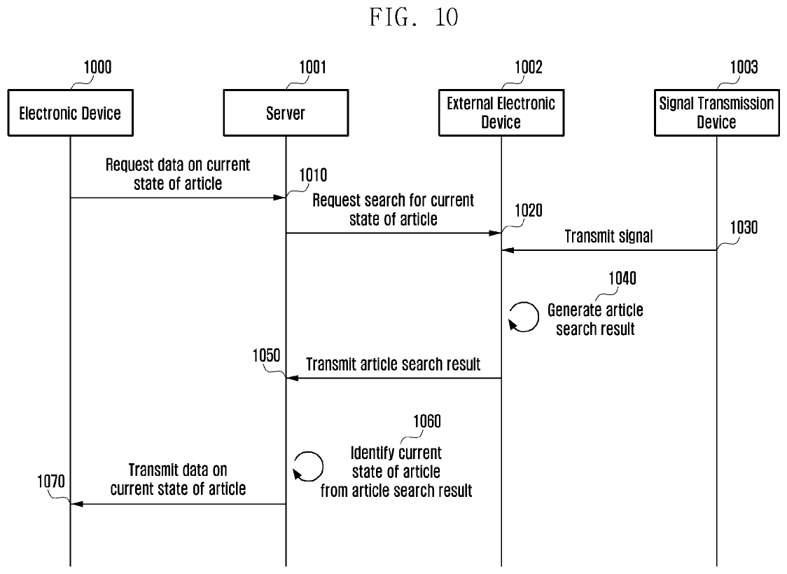

FIG. 10 is a flow diagram illustrating a method for transmitting data related to the current state of an article to an electronic device in an article management method of a server according to various embodiments of the present invention. Here, an electronic device 1000 may be one of the electronic device 101 shown in FIG. 1 or the electronic device 201 shown in FIG. 2. In addition, a server 1001 may be the server 106 shown in FIG. 1. Also, each of an external electronic device 1002 and a signal transmission device 1003 may be one of the electronic devices 102 and 104 shown in FIG. 1.

According to various embodiments of the present invention, at operation 1010, the electronic device 1000 may send a request for data related to a current state of an article to the server 1001. For example, the electronic device 1000 may request the server 1001 to provide data on a current location of an article which is not owned by the user.

According to various embodiments of the present invention, at operation 1020, the server 1001 that receives the request for data related to a current state of an article from the electronic device 1000 may transmit a request for a search for a current state of an article to at least one external electronic device 1002. Here, the external electronic device 1002 is an electronic device capable of receiving a signal from the signal transmission device and identifying the identification data of the signal transmission device contained in the received signal. According to various embodiments of the present invention, the server 1001 may send data on articles to the external electronic device 1002. For example, when data on articles is stored in the server 1001, the server 1001 may transmit the stored data to the external electronic device 1002. If data on articles is not stored in the server 1001, the server 1001 may request the electronic device 1000 to transmit data on articles, receive the data on articles from the electronic device 1000, and transmit the received data to the external electronic device 1002.

According to various embodiments of the present invention, at operation 1030, the signal transmission device 1003 may generate and transmit a signal to the external electronic device 1002, and the external electronic device 1002 may search for and receive the signal transmitted by the signal transmission device 1003. According to various embodiments of the present invention, the signal transmission device 1003 may generate a signal at regular intervals, and the signal generated by the signal transmission device 1003 may include identification data on the signal transmission device 1003.

According to various embodiments of the present invention, at operation 1040, the external electronic device 1002 may generate a result of searching for a current state of an article (hereinafter, “article search result”), based on the signal received from the signal transmission device 1003. For example, the external electronic device 1002 may extract identification data of the signal transmission device from the signal received from the signal transmission device 1003, and compare the extracted data with identification data included in data on articles received from the server 1001. If the identification data extracted from the received signal and the identification data included in the data received from the server 1001 are identical with each other, the external electronic device 1002 may generate the article search result indicating that the identification data matches.

According to various embodiments of the present invention, at operation 1050, the external electronic device 1002 may transmit the generated article search result to the server 1001.

According to various embodiments of the present invention, at operation 1060, the server 1001 may identify data related to the current state of the article requested by the electronic device 1000, based on the article search result received from the external electronic device 1002. For example, when the identification data of the signal received by the external electronic device 1002 matches the identification data of the article related to the request received from the electronic device 1000, the server 1001 may determine that the current location data of the article related to the request of the electronic device 1000 is the current location data of the external electronic device 1002.

According to various embodiments of the present invention, at operation 1070, the server 1001 may send the data related to the current state of the article requested by the electronic device 1000 to the electronic device 1000, and then the electronic device 100 may provide the user with the data received from the server 1001.

According to various embodiments of the present invention, an article management method of an electronic device may comprise operations of determining whether at least one predetermined article management condition occurs; when the article management condition occurs, searching for a signal transmitted by at least one signal transmission device and receiving the signal from the at least one signal transmission device which transmits the signal; constructing a list of articles corresponding to the article management condition, based on a database which contains data on articles and is stored in at least one of the memory and at least one external electronic device; and storing the constructed list of articles corresponding to the article management condition in the electronic device and the at least one external electronic device.

In the method of the electronic device according to various embodiments of the present invention, the article management condition may be set based on at least one of date-related data, day-related data, time-related data, short-range wireless communication data, and GPS coordinate data.

The method of the electronic device according to various embodiments of the present invention may further comprise operations of constructing a list of articles related to the received signal; comparing the list of articles related to the received signal with the list of articles corresponding to the article management condition; determining that an article which is contained in the list of articles corresponding to the article management condition and is not contained in the list of articles related to the received signal is a missed article; and outputting a notification about the missed article when the missed article is included in the list of articles corresponding to the article management condition.

In the method of the electronic device according to various embodiments of the present invention, the operation of constructing a list of articles corresponding to the article management condition may include operations of, when it is determined that the article management condition occurs, retrieving data on an article related to the article management condition in the database; and constructing the list of articles corresponding to the article management condition, based on the data on articles retrieved from the database.

The method of the electronic device according to various embodiments of the present invention may further comprise operations of, when the article related to the received signal is not included in the list of articles corresponding to the article management condition, checking whether the data on articles related to the received signal is included in the database; when the data on articles related to the received signal is included in the database, requesting a user input for performing a function of adding at least one of an article name, an article property, and the article management condition to the data on articles related to the received signal; and when the data on articles related to the received signal is not included in the database, requesting a user input for performing a function of generating the data on articles related to the received signal.

The method of the electronic device according to various embodiments of the present invention may further comprise operations of, when an article related to the received signal is not included in the list of articles corresponding to the article management condition, checking whether data on the article related to the received signal is included in the database; when the data on the article related to the received signal is not included in the database, determining whether the article addition condition is satisfied; and when the article addition condition related to the received signal is satisfied, adding the data on the article related to the received signal to the database.

In the method of the electronic device according to various embodiments of the present invention, the data on articles may include an article property, and the operation of constructing a list of articles corresponding to the article management condition may include operations of identifying at least one of weather-related data and schedule-related data; checking whether data on an article related to at least one of the weather-related data and the schedule-related data is included in the database; and when the data on an article related to at least one of the weather-related data and the schedule-related data is included in the database, adding the article of the data on an article related to at least one of the weather-related data and the schedule-related data to the list of articles corresponding to the article management condition.

The method of the electronic device according to various embodiments of the present invention may further comprise operations of storing at least one of the list of articles related to the received signal, time-related data, and the article management condition in at least one of the memory and the at least one external electronic device; receiving a user input requesting data related to a location of an article; and identifying the data related to the location of an article corresponding to the user input by using the list of articles related to the received signal and at least one of the time-related data and the article management condition.

According to various embodiments of the present invention, an article management method of a server may comprise operations of receiving a request for data related to a current state of an article from an electronic device via the communication module; when receiving the request for data related to the current state of the article from the electronic device, transmitting a request for a search for the current state of the article to at least one external electronic device via the communication module; receiving an article search result from the at least one external electronic device via the communication module; identifying data related to the current state of the article, based on the received article search result; and transmitting the identified data related to the current state of the article to the electronic device via the communication module.

The method of the server according to various embodiments of the present invention may further comprise operations of, when data on the article is stored in the memory, transmitting the stored data on the article to the external electronic device via the communication module; and when the data on the article is not stored in the memory, requesting, via the communication module, the electronic device to transmit the data on the article.

While this disclosure contains many specific implementation details, these should not be construed as limitations on the scope of the disclosure or of what may be claimed, but rather as descriptions of features that may be specific to particular embodiments of particular disclosure.

1. An electronic device comprising:
a display;
a communication module supporting short-range communication;
a processor electrically connected to the display and the communication module; and
a memory electrically connected to the processor,
wherein the memory stores instructions that cause, when executed, the processor to:
determine whether at least one predetermined article management condition occurs,
control the communication module to search for a signal transmitted by at least one signal transmission device and to receive the signal from the at least one signal transmission device which transmits the signal based on an occurrence of the article management condition,
construct a list of articles corresponding to the article management condition, based on a database which contains data on articles and is stored in at least one of the memory and at least one external electronic device, and
store the constructed list of articles corresponding to the article management condition in the memory and the at least one external electronic device.

2. The electronic device of claim 1, wherein the instructions cause the processor to:
construct a list of articles related to the received signal,
compare the list of articles related to the received signal with the list of articles corresponding to the article management condition,
determine that an article which is contained in the list of articles corresponding to the article management condition and is not contained in the list of articles related to the received signal is a missed article, and
output a notification about the missed article when the missed article is included in the list of articles corresponding to the article management condition.

3. The electronic device of claim 1, wherein the instructions cause the processor to:
when it is determined that the article management condition occurs, retrieve data on an article related to the article management condition in the database, and
construct the list of articles corresponding to the article management condition, based on the data on articles retrieved from the database.

4. The electronic device of claim 1, wherein the instructions cause the processor to:
when the article related to the received signal is not included in the list of articles corresponding to the article management condition, check whether the data on articles related to the received signal is included in the database,
when the data on articles related to the received signal is included in the database, request a user input for performing a function of adding at least one of an article name, an article property, and the article management condition to the data on articles related to the received signal, and
when the data on articles related to the received signal is not included in the database, request a user input for performing a function of generating the data on articles related to the received signal.

5. The electronic device of claim 1, wherein the instructions cause the processor to:
when an article related to the received signal is not included in the list of articles corresponding to the article management condition, check whether data on the article related to the received signal is included in the database,
when the data on the article related to the received signal is not included in the database, determine whether the article addition condition is satisfied, and
when the article addition condition related to the received signal is satisfied, add the data on the article related to the received signal to the database.

6. The electronic device of claim 1, wherein the data on articles includes an article property, and
wherein the instructions cause the processor to:
identify at least one of weather-related data and schedule-related data,
check whether data on an article related to at least one of the weather-related data and the schedule-related data is included in the database, and
when the data on an article related to at least one of the weather-related data and the schedule-related data is included in the database, add the article of the data on an article related to at least one of the weather-related data and the schedule-related data to the list of articles corresponding to the article management condition.

7. The electronic device of claim 2, wherein the instructions cause the processor to:
store at least one of the list of articles related to the received signal, time-related data, and the article management condition in at least one of the memory and the at least one external electronic device,
receive a user input requesting data related to a location of an article, and
identify the data related to the location of an article corresponding to the user input by using the list of articles related to the received signal and at least one of the time-related data and the article management condition.

8. A server comprising:
a communication module;
a processor electrically connected to the communication module; and
a memory electrically connected to the processor,
wherein the memory stores instructions that cause, when executed, the processor to:
receive a request for data related to a current state of an article from an electronic device via the communication module,
transmit a request for a search for the current state of the article to at least one external electronic device via the communication module based on receiving the request for data related to the current status of the article from the electronic device;
receive an article search result from the at least one external electronic device via the communication module,
identify data related to the current state of the article, based on the received article search result, and
transmit the identified data related to the current state of the article to the electronic device via the communication module.

9. The server of claim 8, wherein the instructions cause the processor to
when data on the article is stored in the memory, transmit the stored data on the article to the external electronic device via the communication module, and
when the data on the article is not stored in the memory, request, via the communication module, the electronic device to transmit the data on the article.

10. An article management method of an electronic device, the method comprising operations of:
determining whether at least one predetermined article management condition occurs;
searching for a signal transmitted by at least one signal transmission device and receiving the signal from the at least one signal transmission device which transmits the signal based on an occurrence of the article management condition;
constructing a list of articles corresponding to the article management condition, based on a database which contains data on articles and is stored in at least one of the memory and at least one external electronic device; and
storing the constructed list of articles corresponding to the article management condition in the electronic device and the at least one external electronic device.

11. The method of claim 10, further comprising operations of:
constructing a list of articles related to the received signal;
comparing the list of articles related to the received signal with the list of articles corresponding to the article management condition;
determining that an article which is contained in the list of articles corresponding to the article management condition and is not contained in the list of articles related to the received signal is a missed article; and
outputting a notification about the missed article when the missed article is included in the list of articles corresponding to the article management condition.

12. The method of claim 10, wherein the operation of constructing a list of articles corresponding to the article management condition includes operations of:
when it is determined that the article management condition occurs, retrieving data on an article related to the article management condition in the database; and
constructing the list of articles corresponding to the article management condition, based on the data on articles retrieved from the database.

13. The method of claim 10, further comprising operations of:
when the article related to the received signal is not included in the list of articles corresponding to the article management condition, checking whether the data on articles related to the received signal is included in the database;
when the data on articles related to the received signal is included in the database, requesting a user input for performing a function of adding at least one of an article name, an article property, and the article management condition to the data on articles related to the received signal; and
when the data on articles related to the received signal is not included in the database, requesting a user input for performing a function of generating the data on articles related to the received signal.

14. The method of claim 10, further comprising operations of:
when an article related to the received signal is not included in the list of articles corresponding to the article management condition, checking whether data on the article related to the received signal is included in the database;
when the data on the article related to the received signal is not included in the database, determining whether the article addition condition is satisfied; and
when the article addition condition related to the received signal is satisfied, adding the data on the article related to the received signal to the database.

15. The method of claim 10, wherein the data on articles includes an article property, and
wherein the operation of constructing a list of articles corresponding to the article management condition includes operations of:
identifying at least one of weather-related data and schedule-related data;
checking whether data on an article related to at least one of the weather-related data and the schedule-related data is included in the database; and
when the data on an article related to at least one of the weather-related data and the schedule-related data is included in the database, adding the article of the data on an article related to at least one of the weather-related data and the schedule-related data to the list of articles corresponding to the article management condition.
